(19) United States
(12) Patent Application Publication
(10) Pub. No.: US 2016/0161779 A1
(43) Pub. Date: Jun. 9, 2016

(54) Fitting For A Glass Element

(71) Applicant: P.R. AGENTUR FÜR TRANSPARENTE KOMMUNIKATION GMBH, Köln (DE)

(72) Inventors: Peter Reinecke, Numbrecht (DE); Carsten Wild, Engelskirchen (DE)

(21) Appl. No.: 14/780,986

(22) PCT Filed: Mar. 31, 2014
(86) PCT No.: PCT/EP2014/056450

§ 371 Date: Jan. 12, 2016

(30) Foreign Application Priority Data
Mar. 31, 2013 (DE) 10 2013 205 733.4

(51) Int. Cl. G02F 1/133; E06B 9/24

(52) U.S. Cl. CPC G02F 1/13306; E06B 9/24; E06B 2009/2464

(57) ABSTRACT

The invention relates to a fitting (1) for a glass element (5) having at least one drivable liquid crystal film (6). The fitting (1) has at least one interface (8) for at least one control device (12) for driving the liquid crystals (6, 7).

The invention relates to a fitting for a glass element, in particular for a glass window or a glass door.

An LCD screen (liquid crystal screen), which is used for example as a computer screen or television screen, is known from the prior art. The technology of the LCD screen is based on the principle that liquid crystals influence the direction of polarization of light when a voltage is applied. An LCD screen is divided up into numerous picture elements (pixels), which can be electrically activated. In this way it is possible to reproduce graphical representations with the LCD screen. To represent colors, 3 subpixels of each picture element (pixel) are used for the primary colors red, green and blue.

The use of liquid crystals has in the meantime also found its way into glass element technology. For instance, a glass element which is provided with a liquid crystal film is known from the prior art. The liquid crystal film is for example arranged between a first glass plate and a second glass plate. By applying a voltage to the liquid crystal film and by switching the voltage on and off, poles of liquid crystals are oriented, so that the liquid crystal film becomes opaque or transparent. In this way it is possible to make a glass element (for example a glass window or glass door) transparent or untransparent.

It may happen that a liquid crystal film of a glass element has to be inspected and serviced. To do so, it has until now generally been necessary to remove the glass element completely from its mounting. Only after that can the liquid crystal film be inspected. This is on the one hand time-consuming and on the other hand cost-intensive.

The invention is based on the object of providing a possible way of servicing and/or controlling a liquid crystal film in a glass element without it having to be removed completely from its mounting.

This object is achieved according to the invention by a fitting with the features of claim 1. Another fitting according to the invention is given by the features of claim 6. A glass element system with a corresponding fitting is given by the features of claim 9. Further features of the invention emerge from the description that follows, the appended claims and/or the appended drawings.

The fitting according to the invention is intended for a glass element. The glass element is formed for example as a glass window or a glass door. However, it is also explicitly pointed out that the invention is not restricted to use for glass elements. Rather, the invention is suitable for any element with which a liquid crystal film is used, for example a plastic element, in particular a Plexiglas element.

The glass element has at least one activatable liquid crystal film. The fitting is provided with at least one interface for at least one control device for activating the liquid crystal film. In particular, it is envisaged to form the interface as an electronic interface. The interface is for example a hardware interface and/or a network interface, at which the control device for activating the liquid crystal film can be connected. The fitting serves for example for fastening the glass element to a mounting unit, for example a wall of a house or a door frame. The fitting can therefore perform multiple functions. On the one hand, it serves for the fastening of the glass element to the mounting unit. On the other hand, it serves for the connection of a control device, so that the liquid crystal film can be tested, serviced and/or activated. In the case of one embodiment of the invention, it is envisaged to arrange the control device itself physically at the interface. The control device can then for example be operated manually and/or via a wireless Internet connection. In the case of another embodiment, it is provided that the interface itself is formed as a wireless transmitting and receiving unit. This then receives and transmits controlling and measuring signals from and to the control device. For example, the wireless transmitting and receiving unit is formed as an Internet receiving unit.

The invention has the advantage that, by means of the control device that can be connected to the fitting, the liquid crystal film can be serviced and inspected and/or parameters for the operation of the liquid crystal film can be set. Serving for example as parameters are the operating current, the operating voltage and/or possibly the operating temperature.

In the case of one embodiment of the fitting according to the invention, it is additionally or alternatively provided that control lines which are connected to a control unit are arranged at the interface. The control unit serves for activating the liquid crystal film and is formed for example as a microcontroller. In addition or alternatively, it is provided that the control unit has a memory unit with a control program. The control unit is connected to the liquid crystal film via a connecting line or a number of connecting lines. It is consequently possible by means of the control device connected at the interface to program the control unit, so that the liquid crystal film can be activated.

In the case of another embodiment of the fitting according to the invention, it is additionally or alternatively provided that the control device is arranged directly at the interface. For example, the control device is connected to the interface by means of a cable. In the case of another embodiment of the fitting according to the invention, it is provided that a radio unit (for example in the form of a WLAN stick) which communicates with the control device via the Internet, is arranged at the interface. Consequently, remote servicing is possible without any problems.

In the case of yet another embodiment of the fitting according to the invention, it is additionally or alternatively provided that the fitting has an outer side and that the interface is arranged on the outer side of the fitting. The interface is consequently easily accessible. In order to improve the esthetic impression, in the case of one embodiment it is envisaged to provide the interface with a covering which is arranged detachably on the interface. The covering is only removed when the control device is being connected.

In the case of another embodiment of the fitting according to the invention, it is additionally or alternatively provided that the interface is a USB connection. However, the invention is not restricted to a USB connection. Rather, any suitable interface may be used for the invention, for example any suitable parallel interface and any suitable serial interface. In particular, the interface is designed in such a way that it has for example radio transmission technology, infrared transmission technology and/or what is known as Bluetooth transmission technology.

In the case of one embodiment of the fitting according to the invention, it is additionally or alternatively provided that the fitting is formed as a clamping unit and/or as a strap hinge. This allows the fitting to be formed for example as a simple clamp which holds the glass element. In addition or as an alternative to this, it is provided that the fitting is formed as a strap hinge (that is to say as a hinge). This embodiment is suitable in particular for glass elements that are formed as glass doors.

A further fitting according to the invention for a glass element which has at least one activatable liquid crystal film is provided with at least one Internet receiving unit, which is connected to a control unit via at least one control line. The control unit is connected to the liquid crystal film via a connecting line or via a number of connecting lines. In particular, it is provided that the Internet receiving unit is formed as a radio Internet receiving unit. Any of the standards that have already been mentioned further above are suitable for this. In the case of another embodiment of the fitting according to the invention, it is also additionally or alternatively provided here that the fitting has an outer side and that the Internet receiving unit is arranged on the outer side of the fitting.

The invention also relates to a glass element system with at least one glass element which has at least one activatable liquid crystal film. The glass element is arranged at a fitting which has at least one of the features mentioned above or below or a combination of at least two of the aforementioned or following features. As already mentioned above, a glass window or glass door is suitable in particular as the glass element.

The invention is described in more detail below on the basis of exemplary embodiments. In the figures:

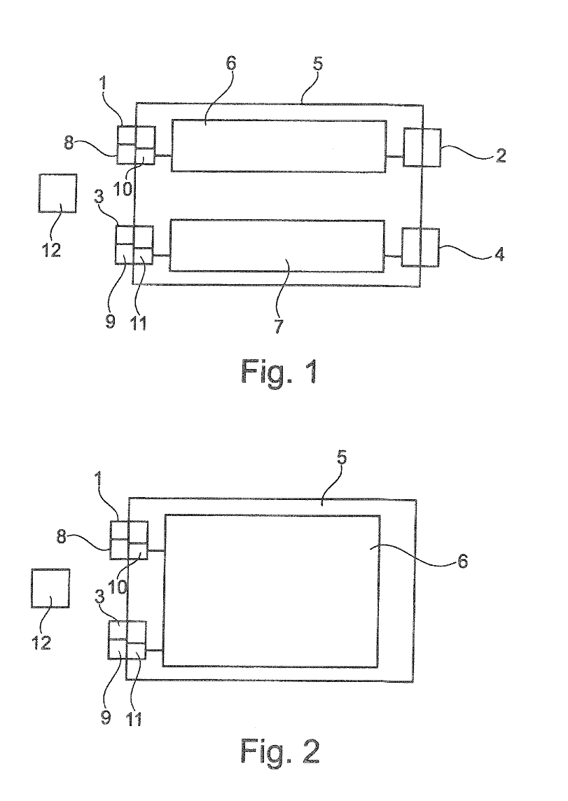

FIG. 1 shows a schematic representation of a glass element in the form of a window with a number of liquid crystal films and a number of fittings;

FIG. 2 shows a schematic representation of a glass door with strap hinges; and

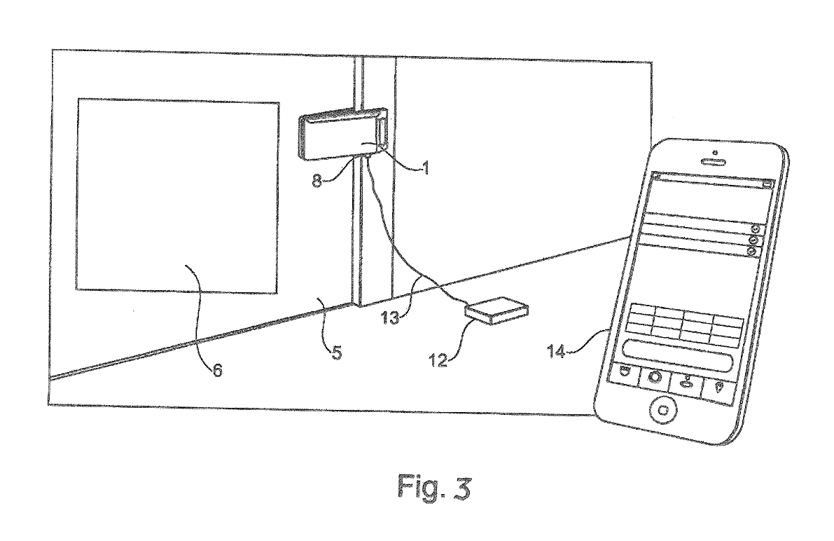

FIG. 3 shows another schematic representation of a glass door with a strap hinge and a control device.

Two types of exemplary embodiment are described below. In the case of a first embodiment, the use of an “external” control device for activating a control unit is provided, a liquid crystal film being controlled by means of the control unit. In the case of a second embodiment, only an “external” control device with which control and monitoring parameters of a liquid crystal film are determined and/or set is provided.

FIG. 1 shows a schematic representation of a glass element 5 in the form of a window, which is fastened to a wall of a house (not represented in FIG. 1) by a first fitting 1, by a second fitting 2, by a third fitting 3 and by a fourth fitting 4. In the case of the exemplary embodiment represented here, the glass element 5 is immovably formed. The first fitting 1, the second fitting 2, the third fitting 3 and the fourth fitting 4 are formed as immovable clamping units. However, it is explicitly pointed out that the invention is not restricted to immovable glass elements. Rather, the invention is also suitable in particular for movable glass elements, for example for movable glass windows or glass doors. This is also explained in more detail further below.

The glass element 5 is provided with a first liquid crystal film 6 and with a second liquid crystal film 7. For example, the first liquid crystal film 6 and the second liquid crystal film 7 are arranged between a first glass plate and a second glass plate.

Arranged at the first fitting 1 is a first interface 8 in the form of a USB connection. Furthermore, the first fitting 1 has a first control unit 10, which is connected to the first liquid crystal film 6 via connecting lines. In addition, the third fitting 3 has a second interface 9 in the form of a USB connection. Also arranged at the third fitting 3 is a second control unit 11, which is connected to the second liquid crystal film 7 via connecting lines. It is explicitly pointed out that the invention is not restricted to the first control unit 10 being arranged at the first fitting 1 and/or the second control unit 11 being arranged at the third fitting 3. Rather, the first control unit 10 and/or the second control unit 11 may be arranged at any other suitable location.

The first control unit 10 serves for activating the first liquid crystal film 6 and is formed for example as a microcontroller. It is also provided that the first control unit 10 has a memory unit with a control program. The second control unit 11 serves for activating the second liquid crystal film 7 and is for example likewise formed as a microcontroller. It is also provided that the second control unit 11 has a memory unit with a control program.

A control device 12 may be connected at the first interface 8 and/or at the second interface 9. For example, the control device 12 is connected to the first interface 8 and/or the second interface 9 by using cables. In the case of another exemplary embodiment, it is provided that the first interface 8 and/or the second interface 9 is/are formed as a radio unit/radio units. The control device 12 then communicates with the first interface 8 and/or the second interface 9 by radio technology. Other embodiments provide wireless communication of the first interface 8, the second interface 9 and/or the control device 12 with one another by means of infrared transmission technology and/or Bluetooth transmission technology. In the case of another exemplary embodiment, it is provided that the first interface 8 and/or the second interface 9 are formed as a wireless transmitting and receiving unit/units. This then receives and transmits controlling and measuring signals from and to the control device 12. For example, the wireless transmitting and receiving unit/units is/are formed as an Internet receiving unit/units. The first liquid crystal film 6 and/or the second liquid crystal film 7 can then be tested, serviced and activated via the Internet.

In the case of the exemplary embodiment represented in FIG. 1, it is provided that the first control unit 10 and/or the second control unit 11 can be activated by means of the control device 12 connected at the first interface 8 and/or the second interface 9. The first control unit 10 then in turn controls the first liquid crystal film 6. Furthermore, the second control unit 11 then in turn controls the second liquid crystal film 7. In this way, the first liquid crystal film 6 and the second liquid crystal film 7 can be serviced and inspected and/or parameters for the operation of the first liquid crystal film 6 or the second liquid crystal film 7 can be set. Serving for example as parameters are the operating current, the operating voltage and/or possibly the operating temperature.

Another exemplary embodiment of the invention is represented in FIG. 2. The exemplary embodiment of FIG. 2 is based on the exemplary embodiment of FIG. 1. The same components are provided with the same designations. As a difference from the exemplary embodiment of FIG. 1, in the case of the exemplary embodiment of FIG. 2 it is provided that the glass element 5 is formed as a glass door, which is only provided with a single liquid crystal film, to be specific the first liquid crystal film 6. The glass element 5 of this exemplary embodiment is fastened to a door frame (not represented in FIG. 2) by a first fitting 1 and by a second fitting 2. The first fitting 1 and the second fitting 2 are formed as strap hinges (hinges). Otherwise, the exemplary embodiment of FIG. 2 has in principle all of the properties, functions and features analogous to the exemplary embodiment of FIG. 1.

FIG. 3 shows a schematic representation of another exemplary embodiment of the invention. This exemplary embodiment does not have a control unit, but only a control device 12, which by means of a cable 13 is arranged at the first interface 8 of a first fitting 1 in the form of a strap hinge. Arranged at the first fitting 1 is a glass element 5 in the form of a glass door. The first interface 8 is formed for example as a USB connection. Furthermore, the first interface 8 is connected via lines to a first liquid crystal film 6, which is arranged in the first glass element 5. The control device 12 is operated by means of an operator control unit 14. For example, the operator control unit 14 is formed as a smart phone or tablet computer, which also displays the parameters of the first liquid crystal film 6 that can be set and/or can be measured. The operation of the control device 12 by means of the operator control unit 14 takes place for example via the Internet. In this way, the first liquid crystal film 6 can be serviced and inspected and/or parameters for the operation of the first liquid crystal film 6 can be set. Serving for example as parameters are the operating current, the operating voltage and/or possibly the operating temperature.

The features of the invention that are disclosed in the present description, in the drawings and also the claims may be essential both individually and in any desired combinations for the implementation of the invention in its various embodiments.

### LIST OF DESIGNATIONS

1 first fitting
2 second fitting
3 third fitting
4 fourth fitting
5 glass element
6 first liquid crystal film
7 second liquid crystal film
8 first interface
9 second interface
10 first control unit
11 second control unit
12 control device
13 cable
14 operator control unit

1. A fitting (1-4) for a glass element (5), which has at least one activatable liquid crystal film (6, 7), characterized in that the fitting (1, 3) has at least one interface (8, 9) for at least one control device (12) for activating the liquid crystal film (6, 7).

2. The fitting (1-4) as claimed in claim 1, characterized in that:
control lines which are connected to a control unit (10, 11) are arranged at the interface (8, 9), and in that
the control unit (10, 11) is connected to the liquid crystal film (6, 7) via a connecting line or a number of connecting lines.

3. The fitting (1-4) as claimed in claim 1, characterized in that:
the fitting (1, 3) has an outer side, and in that
the interface (8, 9) is arranged on the outer side of the fitting (1, 3).

4. The fitting (1-4) as claimed in claim 1, characterized in that the interface is a USB connection.

5. The fitting (1-4) as claimed in claim 1, characterized in that the fitting (1-4) is formed as a clamping unit and/or a strap hinge.

6. A fitting (1-4) for a glass element (5) which has at least one activatable liquid crystal film (6, 7), characterized in that:
the fitting (1, 3) has at least one Internet receiving unit (8, 9), which is connected to a control unit (10, 11) via at least one control line, and in that
the control unit (10, 11) is connected to the liquid crystal film (6, 7) by a connecting line or a number of connecting lines.

7. The fitting (1-4) as claimed in claim 6, characterized in that the Internet receiving unit (8, 9) is formed as a radio Internet receiving unit.

8. The fitting (1-4) as claimed in claim 6 or 7, characterized in that:
the fitting (1, 3) has an outer side, and in that
the Internet receiving unit (8, 9) is arranged on the outer side of the fitting (1, 3).

9. A glass element system, with:
at least one glass element (5) which has at least one activatable liquid crystal film (6, 7), and with
at least one fitting (1-4) as claimed in one of the preceding claims, the fitting (1-4) being arranged on the glass element (5).

10. The glass element system as claimed in claim 9, characterized in that the glass element (5) is formed as a glass window or glass door.
